(19) United States
(12) Patent Application Publication
(10) Pub. No.: US 2007/0070426 A1
(43) Pub. Date: Mar. 29, 2007

(54) Halftone screen generating apparatus to generate a screen considering a compression rate and a screen generating method thereof

(76) Inventor: Hae-kee Lee, Suwon-si (KR)

Correspondence Address: STANZIONE & KIM, LLP, 919 18TH STREET, N.W., SUITE 440, WASHINGTON, DC, 20006, US

(21) Appl. No.: 11/415,144

(22) Filed: May 2, 2006

(30) Foreign Application Priority Data
Sep. 21, 2005 (KR) 2005-87615

(51) Int. Cl. H04N 1/405

(52) U.S. Cl. 358/3.06; 382/232

(57) ABSTRACT

A halftone screen generating apparatus according to a compression rate and a method thereof. The halftone screen generating apparatus includes a cost function application unit to apply a cost function to a screen where an initial pattern is set and to calculate cost values to select a candidate pixel to allocate a screen table value, a candidate pixel selection unit to select candidate pixels having a similar cost value from the cost values calculated by the cost function application unit, a compression rate comparing unit to calculate compression rates of the selected candidate pixels selected by the candidate pixel selection unit and to compare the calculated compression rates of the selected candidate pixels, and a screen table value allocation unit to allocate the screen table value to a candidate pixel having the highest compression rate of the selected candidate pixels based on the compared result of the compression rate comparing unit. Accordingly, as a compressed image size decreases, the transmission rate gets faster so that not only a printing time decreases, but also a memory of the printing apparatus can be efficiently used.

### CROSS-REFERENCE TO RELATED APPLICATIONS

This application claims the benefit under 35 U.S.C. § 119(a) of Korean Patent Application No. 2005-87615, filed Sep. 21, 2005 in the Korean Intellectual Property Office, the entire contents of which are incorporated herein by reference.

### BACKGROUND OF THE INVENTION

1. Field of the Invention

The present general inventive concept relates to a halftone screen generating apparatus of a host apparatus to transmit printing data to a printing apparatus and a screen generating method thereof. More particularly, the present general inventive concept relates to a halftone screen generating apparatus to generate a halftone screen to perform halftoning by considering a compression rate to downsize a compressed image on transmission, and a method thereof.

2. Description of the Related Art

In general, a printing apparatus has a binary-level of two states based on whether or not to output a dot, unlike an image apparatus having a multi-level image capability. A method of printing a multi-level input image in a binary-level is called “halftoning.”

More specifically, an image having brightness values of 256 levels of 0 to 255 is a gradation image, a method of expressing the continuous gradation image in only 0 (black) and 255 (white) using a halftone screen is halftoning, and an image generated by the halftoning is a binary image.

When a host apparatus transmits a printing image to the printing apparatus, a binary image is generated by halftoning the printing image. The host apparatus applies a compression algorithm to the binary image and transmits the compressed binary image to the printing apparatus.

A size of the compressed image determines a transmission time to the printing apparatus and a memory capacity in the printing apparatus. More particularly, when the compressed image size is large, the transmission time to the printing apparatus is long so that a printing time is also long. Additionally, if the size of the compressed image is large, the memory capacity of the printing apparatus also has to be large.

However, a conventional halftone screen generating apparatus in the host apparatus does not consider a compression rate in a process of generating a screen through halftoning. Instead, the conventional halftone screen generating apparatus sets an initial pattern to generate the screen and determines center dots of super cells to construct the screen. The conventional halftone screen generating apparatus sequentially determines an order of dots of a pixel to print next using a spot function so that the screen is completed. Accordingly, the compression rate is never considered by the conventional halftone screen generating apparatus upon generating the screen.

### SUMMARY OF THE INVENTION

The present general inventive concept generates a screen considering a compression rate upon generating a halftone screen, since the compression rate of an image depends on the screen that is used to halftone a binary image. The present general inventive concept provides a halftoning screen generating apparatus to generate a screen considering the compression rate to reduce a size of a compressed image upon transmission and a screen generating method thereof.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a halftone screen generating apparatus, including a cost function application unit to apply a cost function to a screen where an initial pattern is set and to calculate cost values to select a candidate pixel to allocate a screen table value, a candidate pixel selection unit to select candidate pixels having a similar cost value from the cost values calculated by the cost function application unit, a compression rate comparing unit to calculate compression rates of the selected candidate pixels selected by the candidate pixel selection unit and to compare the calculated compression rates of the selected candidate pixels, and a screen table value allocation unit to allocate the screen table value to a candidate pixel having the highest compression rate of the selected candidate pixels based on the compared result of the compression rate comparing unit.

The compression rate comparing unit may compress a binary image generated after halftoning using the screen when allocating the screen table value to the selected candidate pixels, respectively, and may calculate the compression rates.

The compression rate comparing unit may calculate the compression rates according to the Joint Bi-level Image Experts Group (JBIG) standard.

Further, the cost function application unit may calculate the cost values to enable one of uniformity, stability, and banding.

Further, the screen table value may be the printing determination order.

The foregoing and/or other aspects of the present general inventive concept are also achieved by providing a screen generating method of a halftone screen generating apparatus, the method including applying a cost function to a screen where an initial pattern is set and calculating cost values to select candidate pixels for which to allocate a screen table value, selecting the candidate pixels having a similar cost value to the calculated cost value, calculating compression rates of the selected candidate pixels and comparing the calculated compression rates of the selected candidate pixels, and allocating the screen table value to a candidate pixel having the highest compression rate of the selected candidate pixels based on the compared result.

The calculating of the compression rates may include compressing a binary image generated after halftoning using the screen when allocating the screen table value to the selected candidate pixels respectively.

Further, the compression rates may be calculated according to the Joint Bi-level Image Experts Group (JBIG) standard.

The calculating of the cost values may include calculating the cost values to enable one of uniformity, stability, and banding.

The screen table value may be the printing determination order.

The foregoing and/or other aspects of the present general inventive concept are also achieved by providing a host apparatus, including a screen generating apparatus to generate a halftone screen by allocating a screen table value to a candidate pixel having a highest compression rate from among a plurality of candidate pixels having a similar cost value.

The foregoing and/or other aspects of the present general inventive concept are also achieved by providing a screen generating apparatus, including a compression rate ordering unit to order pixels of a screen for printing based on compression rates in decreasing order.

The foregoing and/or other aspects of the present general inventive concept are also achieved by providing a screen generating apparatus, including a compression rate unit to select a pixel having a high compression rate to represent other similar pixels having lower compression rates.

The foregoing and/or other aspects of the present general inventive concept are also achieved by providing a computer readable medium containing executable code to perform a screen generating method, the method including applying a cost function to a screen where an initial pattern is set and calculating cost values to select candidate pixels for which to allocate a screen table value, selecting candidate pixels having a similar cost value from calculated cost values, calculating compression rates of the selected candidate pixels and comparing the calculated compression rates of the selected candidate pixels, and allocating the screen table value to a candidate pixel with the highest compression rate of the selected candidate pixels based on the compared result.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a block diagram illustrating a halftone screen generating apparatus according to an embodiment of the present general inventive concept; and

FIG. 2 is a flow chart illustrating a screen generating method usable in a halftone screen generating apparatus according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

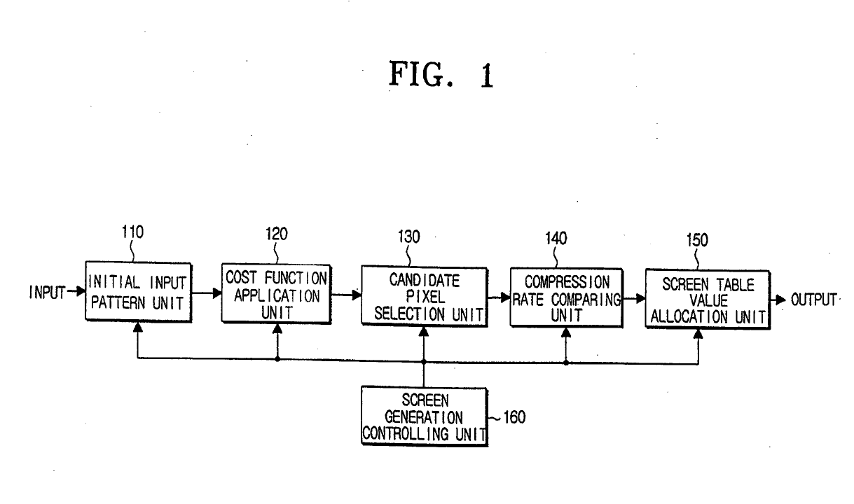

FIG. 1 is a block diagram illustrating a halftone screen generating apparatus according to an embodiment of the present general inventive concept. The halftone screen generating apparatus generates a screen considering a compression rate. The halftone screen generating apparatus does not generate a screen with a new particular pattern, but instead generates a screen with a maximum compression rate in a range where a pattern of a desired screen of the existing screen does not change.

Referring to FIG. 1, the halftone screen generating apparatus includes an initial input pattern unit 110, a cost function application unit 120, a candidate pixel selection unit 130, a compression rate comparing unit 140, a screen table value allocation unit 150, and a screen generation controlling unit 160. The halftone screen generating apparatus of FIG. 1 may further include a halftone unit (not shown) to generate a halftone screen. The halftone screen may represent a multi-level image as a binary level image.

The initial input pattern unit 110 sets an initial input pattern to generate a screen. More specifically, when generating a clustered screen, the initial input pattern unit 110 sets a state in which a location of a center dot is selected as the initial input pattern. When generating a dispersed screen, the initial input pattern unit 110 sets a pattern of a certain level which is equally dispersed as the initial input pattern.

The cost function application unit 120 applies a cost function (evaluation function) to the screen where the initial input pattern is set by the initial input pattern unit 110 and calculates a cost values which can select a candidate pixel to print next. The cost function calculates an influence of adjacent dots on one dot center as a cost value to enable uniformity, stability, and banding.

The cost function application unit 120 calculates the cost values with a cost function that is suitable for Joint Bi-level Image Experts Group (JBIG), which is a standard of image compression for bi-level images.

The candidate pixel selection unit 130 selects candidate pixels with the same cost value from the cost values calculated by the cost function application unit 120. If the candidate pixels with the same cost value do not exist, the compression rate can not be considered, so that the candidate pixel selection unit 130 selects candidate pixels with the similar cost values to maximize the compression rate.

The compression rate comparing unit 140 calculates the compression rate(s) of the candidate pixels with the same cost value selected by the candidate pixel selection unit 130 when selected, respectively, according to the JBIG standard, and compares the calculated compression rates. More specifically, it is assumed that the compression rate comparing unit 140 performs halftoning using the screen, if a screen table value (i.e., a printing determination order), is allocated to the candidate pixels, respectively. The compression rate comparing unit 140 compresses a binary image generated upon halftoning and calculates a size of the compressed binary image. The compression rate comparing unit 140 compares the compression sizes calculated for each of the candidate pixels. The printing determination order indicates an order in which pixels are to be compressed, transmitted from the host apparatus to a printer, decompressed by the printer, and printed by the printer.

The screen table value allocation unit 150 allocates the printing determination order to a candidate pixel having the smallest compression size (i.e., the highest compression rate) according to the compared result from the compression rate comparing unit 140.

The screen generation controlling unit 160 controls the halftone screen generating apparatus to repeatedly perform the above process until the printing determination order is allocated to all the pixels of the screen table so that the screen is generated.

Accordingly, a screen that minimizes the size of the compressed image after halftoning can be generated in a range in which the pattern of the desired screen does not change.

In other words, the compression rate comparing unit 140 selects the candidate pixel having the highest compression rate and the lowest compression size from among candidate pixels such that each of the candidate pixels having similar cost values can be represented by the selected candidate pixel. The similar cost values may indicate a pattern in the desired screen that does not change (e.g., a run). Since the selected candidate pixel has the highest compression rate, compression rates of each of the candidate pixels that are represented by the selected candidate pixel can be increased, thereby increasing an overall compression rate of an image on the desired screen.

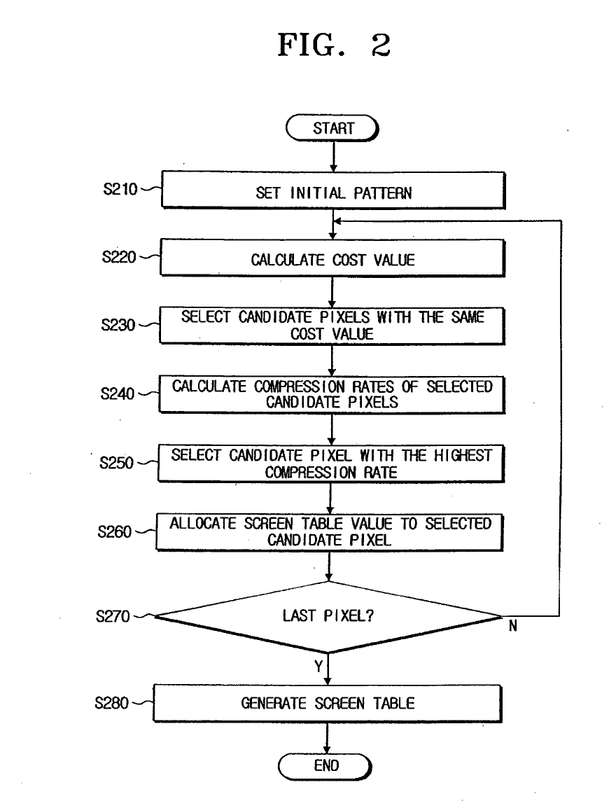

FIG. 2 is a flow chart illustrating a screen generating method usable in a halftone screen generating apparatus according to an embodiment of the present general inventive concept. The method of FIG. 2 may be performed by the halftone screen generating apparatus of FIG. 1. Accordingly, for illustration purposes, the method of FIG. 2 is described below with reference to FIG. 1.

Referring to FIG. 2, when an image is input, the initial input pattern unit 110 sets the initial pattern to generate a screen (operation S210).

The cost function application unit 120 applies the cost function to the screen having the initial pattern set by the initial input pattern unit 110 and calculates the cost value(s) to select a candidate pixel to print next (operation S220).

The candidate pixel selection unit 130 selects candidate pixels with the same (or a similar) cost value from the cost value(s) calculated by the cost function application unit 120 (operation S230).

The compression rate comparing unit 140 calculates the compression rates of the candidate pixels with the same cost value selected by the candidate pixel selection unit 130 when selected, respectively, according to the JBIG standard (operation S240).

The compression rate comparing unit 140 selects a candidate pixel with the highest compression rate (i.e., the lowest compression size) by comparing the calculated compression rates (operation S250).

The screen table value allocation unit 150 allocates a screen table value (i.e., to determine the printing determination order) to the candidate pixel with the highest compression rate according to the compared result from the compression rate comparing unit 140 (operation S260).

The screen generation controlling unit 160 determines whether the candidate pixel is the last pixel of the screen (operation S270).

If the candidate pixel is not the last pixel (S270-N), the screen generation controlling unit 160 controls the halftone screen generating apparatus to repeat the process from the operation S220 until a screen table value is allocated to the last pixel of the screen.

If the candidate pixel is the last pixel (S270-Y), the screen generation controlling unit 160 generates the screen table, that is, the screen in order for each pixel of the screen to have the printing determination order allocated by the screen table value allocation unit 150 (operation S280).

The present general inventive concept can be embodied as computer-readable code/instructions/programs and can be implemented in general-use digital computers that execute the code/instructions/programs using a computer-readable recording medium. Examples of the computer-readable recording medium include magnetic storage media (e.g., ROM, floppy disks, hard disks, etc.), optical recording media (e.g., CD-ROMs, or DVDs), and storage media such as carrier waves (e.g., transmission through the internet). Further, the present general inventive concept can be embodied as a computer-readable recording medium having computer-readable code, and the computer-readable recording medium can also be distributed over network-coupled computer systems so that the computer-readable code is stored and executed in a distributed fashion. Also, functional programs, code, and code segments for accomplishing the present general inventive concept can be easily construed by programmers skilled in the art to which the present general inventive concept pertains.

As can be appreciated from the above description, as a size of a compressed image decreases according to the various embodiments of the present general inventive concept, a transmission rate to a printing apparatus gets faster so that not only is a printing time reduced but also a memory capacity of the printing apparatus can be efficiently used.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A halftone screen generating apparatus, comprising:
a cost function application unit to apply a cost function to a screen where an initial pattern is set and to calculate cost values to select a candidate pixel for which to allocate a screen table value;
a candidate pixel selection unit to select candidate pixels with a similar cost value from the cost values calculated by the cost function application unit;
a compression rate comparing unit to calculate compression rates of the candidate pixels selected by the candidate pixel selection unit and to compare the calculated compression rates of the selected candidate pixels; and
a screen table value allocation unit to allocate the screen table value to a candidate pixel with the highest compression rate of the selected candidate pixels based on the compared result of the compression rate comparing unit.

2. The apparatus of claim 1, wherein the compression rate comparing unit compresses a binary image generated after halftoning using the screen when allocating the screen table value to the selected candidate pixels, respectively, and calculates the compression rates.

3. The apparatus of claim 1, wherein the compression rate comparing unit calculates the compression rates according to the Joint Bi-level Image Experts Group (JBIG) standard.

4. The apparatus of claim 1, wherein the cost function application unit calculates the cost value to enable uniformity, stability, and banding.

5. The apparatus of claim 1, wherein the screen table value comprises a printing determination order.

6. The apparatus of claim 5, wherein the printing determination order comprises an order in which pixels of the screen are compressed, transmitted to a printer, decompressed by the printer, and printed by the printer.

7. The apparatus of claim 1, wherein the compression rate comparing unit determines a pattern of pixels of the screen and selects one of the pixels of the pattern having the highest compression rate to represent other pixels in the pattern.

8. A screen generating apparatus, comprising:
a compression rate ordering unit to order pixels of a screen for printing based on compression rates in decreasing order.

9. The apparatus of claim 8, further comprising:
a halftone unit to generate a halftone screen to represent a multi-level image as a binary level image and to provide the screen to the compression rate ordering unit.

10. The apparatus of claim 8, further comprising:
a cost unit to determine a plurality of pixels having similar cost values and to provide a determination of the pixels having the similar cost values to the compression rate ordering unit.

11. The apparatus of claim 10, wherein the compression ordering unit calculates compression rates of the plurality of pixels having the similar cost values, compares the calculated compression rates, and allocates screen table values to the plurality of pixels having the similar cost values according to the comparison.

12. The apparatus of claim 10, wherein the compression ordering unit comprises:
a compression rate comparing unit to compare compression rates of the plurality of pixels having the similar cost values and to select a pixel having a highest compression rate as a next pixel to be printed; and
a screen table value allocation unit to allocate screen table values to each of the pixels according to the respective compression rates.

13. A screen generating apparatus, comprising:
a compression rate unit to select a pixel having a high compression rate to represent other similar pixels having lower compression rates.

14. The apparatus of claim 13, further comprising:
a halftone unit to generate a screen to represent a multi-level image as a binary level image and to provide the screen to the compression rate unit.

15. The apparatus of claim 13, further comprising:
a cost unit to determine a pattern of pixels in which a screen does not change by calculating a plurality of cost values and to provide the cost values to the compression rate unit.

16. The apparatus of claim 15, wherein the compression rate unit comprises:
a pixel selection unit to select a plurality of pixels having similar cost values;
a comparison unit to determine compression rates of the plurality of pixels having the similar cost values and to select a pixel having a largest compression rate from among the plurality of pixels having the similar cost values; and
a screen table value allocation unit to allocate a next print pixel as the selected pixel having the largest compression rate.

17. A screen generating method of a halftone screen generating apparatus, the method comprising:
applying a cost function to a screen where an initial pattern is set and calculating cost values to select candidate pixels for which to allocate a screen table value;
selecting candidate pixels having a similar cost value from calculated cost values;
calculating compression rates of the selected candidate pixels and comparing the calculated compression rates of the selected candidate pixels; and
allocating the screen table value to a candidate pixel with the highest compression rate of the selected candidate pixels based on the compared result.

18. The method of claim 17, wherein the calculating of the compression rates comprises calculating the compression rates by compressing a binary image generated after halftoning using the screen when allocating the screen table value to the selected candidate pixels, respectively.

19. The method of claim 17, wherein the compression rates are calculated according to the Joint Bi-level Image Experts Group (JBIG) standard.

20. The method of claim 17, wherein the calculating of the cost values comprises calculating of the cost values to enable one of uniformity, stability, and banding.

21. The method of claim 17, wherein the screen table value comprises the printing determination order.

22. A host apparatus, comprising:
a screen generating apparatus to generate a halftone screen by allocating a screen table value to a candidate pixel having a highest compression rate from among a plurality of candidate pixels having a similar cost value.

23. A computer readable medium containing executable code to perform a screen generating method, the method comprising:
applying a cost function to a screen where an initial pattern is set and calculating cost values to select candidate pixels for which to allocate a screen table value;
selecting candidate pixels having a similar cost value from calculated cost values;
calculating compression rates of the selected candidate pixels and comparing the calculated compression rates of the selected candidate pixels; and
allocating the screen table value to a candidate pixel with the highest compression rate of the selected candidate pixels based on the compared result.
